(19) United States
(12) Patent Application Publication
(10) Pub. No.: US 2012/0033424 A1
(43) Pub. Date: Feb. 9, 2012

(54) LED LIGHTBULB WITH IMPROVED GAIN STRUCTURE

(76) Inventor: HSU LI YEN, TAIPEI COUNTY (TW)

(21) Appl. No.: 12/850,796

(22) Filed: Aug. 5, 2010

(51) Int. Cl. F21S 8/00

(52) U.S. Cl. 362/249.02

(57) ABSTRACT

An LED lightbulb with an improved gain structure has a die-type LED lamp with the light-emitting dies arranged and a structure for preventing insects from intruding into the lamp, including a base casing, a heat dissipating unit coupled with the LED lamp, meshes, and a transparent cover, and characterized in that the LED lamp has a middle portion defined with a matrix arrangement region for the light-emitting dies. Rows of the light-emitting dies are disposed at the periphery of the matrix arrangement region. The light-emitting dies disposed at the periphery of the matrix arrangement region are spaced apart from the light-emitting dies disposed within the matrix arrangement region, respectively. The meshes adhere to the base casing and correspond in position to the air holes, respectively, to prevent intrusion of insects and thereby protect the LED lamp against short circuits.

### BACKGROUND OF THE INVENTION

1. Technical Field

The present invention relates LED lamps, and more particularly, to an LED lightbulb with an improved gain structure.

2. Description of Related Art

Living spaces nowadays are illuminated by various lamps. In spaces, lamps are positioned as needed and configured to emit light for providing brightness in the spaces. Hence, lighting equipment is important to living spaces, as the light it emits not only enhances the quality of the living spaces, but is closely correlated with the health of the human body and the human eye.

In general, basic lighting is intended to illuminate a space and thereby ensure an unblocked view thereof. Hence, the stability of the light emitted by basic lighting has a direct effect on the human eye. Also, there are growing concerns for the manufacturing process of lamps, raw materials used in the process, environmental protection-related issues regarding the recycling of the raw materials, and high power consumption of light.

Recently, there are some instances of unfavorable international coverage of the negative effect of conventional lamps on the human health and environmental protection. At present, the international community is replacing conventional lamps with LED lamps. LED lamps are absolutely free from problems with environmental protection and health hazards. Also. LED lamps excel conventional lamps in the brightness and stability of illumination, not to mention that LED lamps are extremely power-saving. Hence, LED lamps are very popular with consumers.

Since LED lamps generate heat when emitting light, dissipation of heat generated by an LED lamp is speeded up by ventilation holes formed on a housing of the LED lamp and a heat dissipating unit. However, insects are likely to intrude into the LED lamps through such ventilation holes to thereby cause short circuits to the LED lamps. Also, light-emitting dies of LED lamps are usually arranged in a matrix and thus fail to meet the need for a wide variety of lamp patterns (that is, patterns other than a matrix).

Considering the urgent need to overcome the above drawbacks of the prior art, the inventor of the present invention conducted studies and experiments continually, and eventually devised an improved structural design.

Examiners of related patent authorities are hereby requested to refer to the appended drawings and embodiments when looking into the structures, methods, objectives, and spirit of the present invention, so as to gain insight into the present invention.

### BRIEF SUMMARY OF THE INVENTION

An LED lightbulb with an improved gain structure, configured to improve LED lamp pattern design and arrangement of light-emitting dies, has a die-type LED lamp with the light-emitting dies desirably arranged and a structure for preventing insects from intruding into the lamp, including a base casing, a heat dissipating unit coupled with the LED lamp, meshes, and a transparent cover, and characterized in that the LED lamp has a middle portion defined with a matrix arrangement region for the light-emitting dies. Rows of the light-emitting dies are disposed at the periphery of the matrix arrangement region. The light-emitting dies disposed at the periphery of the matrix arrangement region are spaced apart from the light-emitting dies disposed within the matrix arrangement region, respectively. The meshes adhere to the base casing and correspond in position to the air holes, respectively, to prevent intrusion of insects and thereby protect the LED lamp against short circuits.

### BRIEF DESCRIPTION OF THE SEVERAL VIEWS OF THE DRAWINGS

FIG. 1 is a schematic perspective view of an assembled LED lightbulb with an improved gain structure of the present invention;

FIG. 2 is a schematic view of an LED lamp of the present invention; and

FIG. 3 is a concise schematic view of the arrangement of light-emitting dies of the LED lamp of the present invention.

### DETAILED DESCRIPTION OF THE INVENTION

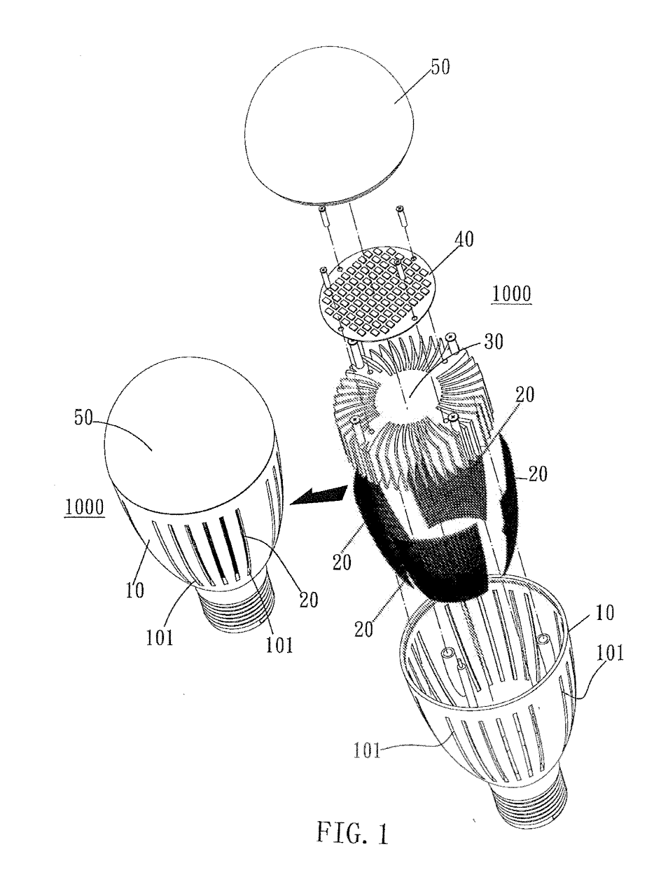

FIG. 1 is a schematic perspective view of an assembled LED lightbulb with an improved gain structure of the present invention. As shown in the drawing, an LED lightbulb 1000 with an improved gain structure according to the present invention comprises: a base casing 10 with a plurality of air holes 101; meshes 20 adhering to an inner side of the base casing 10 and corresponding in position to the air holes 101, respectively; a heat dissipating unit 30 coupled to the inside of the base casing 10; an LED lamp 40 coupled with heat dissipating unit 30; and a transparent cover 50 positioned atop, wherein the meshes 20 prevent insects from intruding into the LED lightbulb 1000 through the air holes 101, thereby protecting the LED lightbulb 1000 against short circuits.

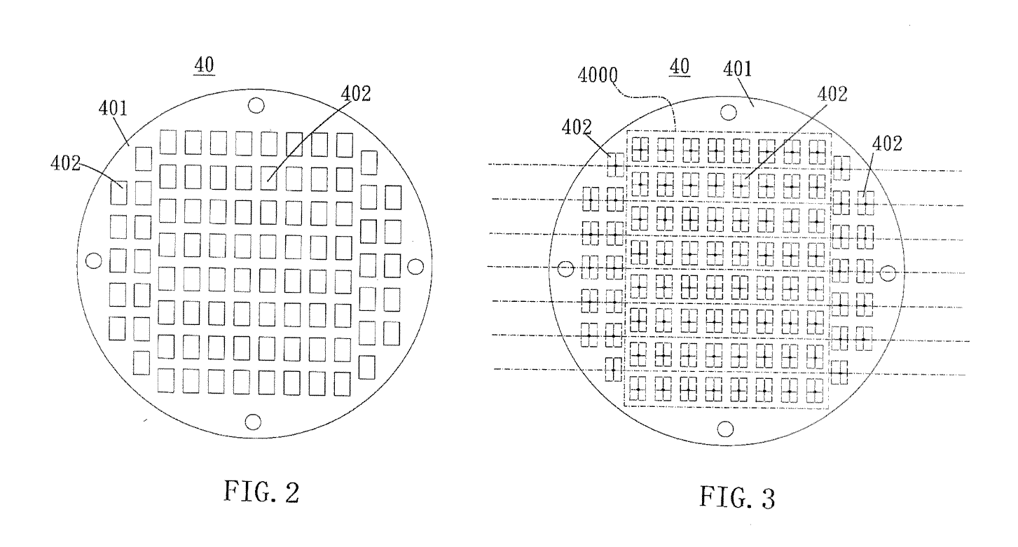

FIG. 2 is a schematic view of an LED lamp of the present invention. As shown in the drawing, light-emitting dies 402 are disposed across a substrate 401. Referring to FIG. 3, which is a concise schematic view of the arrangement of light-emitting dies of the LED lamp of the present invention, the LED lamp 40 has a middle portion defined with a matrix arrangement region 4000 intended for the light-emitting dies 402, wherein a plurality of rows of the light-emitting dies 402 are disposed at the periphery of the matrix arrangement region 4000. The light-emitting dies 402 disposed at the periphery of the matrix arrangement region 4000 are spaced apart from the light-emitting dies 402 disposed within the matrix arrangement region 4000, respectively. The plurality of rows of the light-emitting dies 402 is disposed at four sides, one side, two sides, or three sides of the periphery of the matrix arrangement region 4000. The light-emitting dies 402 are quantitatively variable to form different patterns (including patterns other than a rectangle) of the LED lamp 40 regarding the arrangement of the light-emitting dies 402.

In conclusion, the present invention demonstrates novel effects, involves an inventive step, has never been published or applied, and has high industrial applicability. Hence, the applicant of the present invention hereby files a patent application with related patent authorities and expects that the related patent authorities will allow the patent application.

It should be noted that the above descriptions pertain to preferred embodiments of the present invention. All changes which are made to the preferred embodiments of the present invention according to the concepts thereof and bring about a desired function or effect without departing from the spirit embodied in the specification and drawings should be deemed falling within the scope of the present invention.

What is claimed is:

1. An LED lightbulb with an improved gain structure, comprising: a base casing having a plurality of air holes, meshes adhering to an inner side of the base casing and corresponding in position to the air holes, respectively, a heat dissipating unit coupled to the inside of the base casing; an LED lamp coupled with the heat dissipating unit, and a transparent cover positioned atop, and being characterized in that:
the LED lamp comprises light-emitting dies disposed across a substrate and has a middle portion defined with a matrix arrangement region intended for the light-emitting dies, a plurality of rows of the light-emitting dies being disposed at a periphery of the matrix arrangement region, the light-emitting dies disposed at the periphery of the matrix arrangement region being spaced apart from the light-emitting dies disposed within the matrix arrangement region, respectively, the plurality of rows of the light-emitting dies being disposed at four sides, one side, two sides, or three sides of the periphery of the matrix arrangement region, and the light-emitting dies being quantitatively variable to form different light-emitting patterns of the LED lamp.

2. The LED lightbulb of claim 1, wherein the meshes prevent insects from intruding into the LED lightbulb through the air holes, thereby protecting the LED lightbulb against short circuits.
